(19) United States
(12) Patent Application Publication
(10) Pub. No.: US 2014/0331452 A1
(43) Pub. Date: Nov. 13, 2014

(54) ELECTRONIC DEVICE AND HINGE STRUCTURE

(71) Applicant: Wistron Corporation, New Taipei City (TW)

(72) Inventor: Lian-Jun Zhang, New Taipei City (TW)

(21) Appl. No.: 13/920,097

(22) Filed: Jun. 18, 2013

(30) Foreign Application Priority Data
May 7, 2013 (CN) 201310165002.1

(51) Int. Cl. E05D 11/08

(52) U.S. Cl. CPC E05D 11/087
USPC 16/337

(57) ABSTRACT

An electronic device includes a first body, a second body and a hinge structure. The hinge structure includes a shaft, a bracket, a torsion assembly and a first washer. The shaft is fixed to the first body. The bracket is fixed to the second body and rotatably connected to the shaft. The bracket includes two assembling portions fixed to each other. The torsion assembly is disposed on the shaft and provides torsion to the hinge structure. The first washer is fixed to the shaft and located between the two assembling portions. Two sides of the first washer contact the two assembling portions respectively to increase the torsion of the hinge structure through the frictional force between the first washer and the two assembling portions.

### CROSS-REFERENCE TO RELATED APPLICATION

This application claims the priority benefit of China application serial no. 201310165002.1, filed on May 7, 2013. The entirety of the above-mentioned patent application is hereby incorporated by reference herein and made a part of this specification.

### BACKGROUND

1. Field of the Application

The invention relates to a hinge structure and an electronic device having the same, and more particularly, to a hinge structure including a torsion assembly and an electronic device having the same.

2. Description of Related Art

Benefitting from the advancement of semiconductor element and display technologies, electronic devices have been continuously developed toward directions of being small, versatile and easy to carry, and commonly seen portable electronic devices include a tablet PC, a smart phone, a notebook computer and so forth. Taken the notebook computer as an example, the general notebook computer is mostly composed of a host and a display, wherein the host and the display are coupled with each other through a hinge structure. A user may close the host with the display of the notebook computer for easy carrying via a relative rotation between the host and the display, and then the display can be expanded from the host to facilitate the operation when the user wants to use the notebook computer.

In general, the hinge structure of the notebook computer provides a torsion required by the notebook computer during opening and closing through fractional force generated between components such as washers, and a torsion test is required to be performed in phases of producing the notebook computer so as to ensure the torsion provided by the hinge structure thereof is prevented from being excessive attenuated due to repetitive openings and closings of the display. Following a thinning developmental trend of the notebook computer, a space in the notebook computer for accommodating the hinge structure is limited, and therefore, how to enable the hinge structure to have sufficient frictional interfaces within a limited accommodation space and reduce an attenuation degree of the torsion of the hinge structure have become the current most essential issues for the hinge design.

### SUMMARY OF THE APPLICATION

The invention provides an electronic device, and a hinge structure thereof has sufficient frictional interfaces to reduce an attenuation degree of torsion thereof.

The invention provides a hinge structure having sufficient frictional interfaces to reduce an attenuation degree of torsion thereof.

The electronic device of the invention includes a first body, a second body and a hinge structure. The hinge structure includes a shaft, a bracket, a torsion assembly and a first washer. The shaft is fixed to the first body. The bracket is fixed to the second body and rotatably connected to the shaft. The bracket includes two assembling portions fixed to each other. The torsion assembly is disposed at the shaft and provides torsion to the hinge structure. The first washer is fixed to the shaft and located between the two assembling portions. Two sides of the first washer contact the two assembling portions respectively to increase the torsion of the hinge structure through frictional force between the first washer and the two assembling portions.

The hinge structure of the invention is adapted to be used in an electronic device, the electronic device includes a first body and a second body, and the hinge structure includes a shaft, a bracket, a torsion assembly and a first washer. The shaft is fixed to the first body. The bracket is fixed to the second body and rotatably connected to the shaft. The bracket includes two assembling portions fixed to each other. The torsion assembly is disposed at the shaft and provides torsion to the hinge structure. The first washer is fixed to the shaft and located between the two assembling portions. Two sides of the first washer contact the two assembling portions respectively to increase the torsion of the hinge structure through frictional force between the first washer and the two assembling portions.

In an embodiment of the invention, the shaft has a stopper portion, and the torsion assembly includes a pressing element, a second washer and a plurality of elastic pieces. The pressing element is fixed to the shaft, wherein the bracket is located between the stopper portion and the pressing element, and the pressing element provides a pressure toward the stopper portion along an axial direction of the shaft. The second washer is fixed to the shaft and located between the bracket and the pressing element, wherein the second washer contacts the bracket to provide torsion through frictional force between the second washer and the bracket. The elastic pieces are disposed at the shaft and located between the second washer and the pressing element, wherein the pressing element transmits the pressure toward the stopper portion through the elastic pieces.

In an embodiment of the invention, the bracket contacts the stopper portion to provide torsion to the hinge structure through frictional force between the bracket and the stopper portion.

In an embodiment of the invention, the torsion assembly further includes a convex cam and a concave cam, the convex cam and the concave cam are located between the second washer and the elastic pieces, the convex cam is fixed to the shaft and has a first friction surface, the concave cam is fixed to the bracket and has a second friction surface, and the first friction surface and the second friction surface are configured to contact with each other to provide torsion to the hinge structure through frictional force between the convex cam and the concave cam.

In an embodiment of the invention, the convex cam has a first guiding inclined plane adjacent to the first friction surface, the concave cam has a second guiding inclined plane adjacent to the second friction surface, when an angle between the first body and the second body is greater than a preset angle, the first friction surface and second friction surface contact with each other, and when the angle between the first body and the second body is reduced to the preset angle following a rotation of the bracket in relative to the shaft, the first guiding inclined plane begins to contact with the second guiding inclined plane and the pressure provided by the pressing element drives the first guiding inclined plane to slide in relative to the second guiding inclined plane, so that the bracket continues to rotate in relative to the shaft and drives the first body to be closed to the second body.

In an embodiment of the invention, the second washer contacts the concave cam to provide torsion to the hinge structure through frictional force between the second washer and the concave cam.

In an embodiment of the invention, a surface of the concave cam is configures to contact the second washer, the surface has a plurality of grooves, and the grooves are configured to accommodate lubricating oil.

In an embodiment of the invention, a surface of the second washer is configures to contact the bracket, the surface has a plurality of grooves, and the grooves are configured to accommodate lubricating oil.

In an embodiment of the invention, a surface of the first washer is configures to contact the bracket, the surface has a plurality of grooves, and the grooves are configured to accommodate lubricating oil.

According to the foregoing, the bracket of the invention is composed of the two assembling portions fixed to each other, and the two assembling portions are disposed with the first washer therebetween, so as to enable the hinge structure to have more frictional interfaces through the contacts between the first washer and each of the assembling portions. As such, the hinge structure, in addition to providing the torsion required by the electronic device during the opening and closing of the first body and the second body via the torsion assembly, may also further increase the torsion through the frictional force between the first washer and the two assembling portions, so as to prevent the torsion of the hinge structure from an excessive attenuation due to repetitive openings and closings of the first body and the second body, and thereby enhance a durability of the electronic device.

In order to make the aforementioned and other features and advantages of the present application more comprehensible, several embodiments accompanied with figures are described in detail below.

### BRIEF DESCRIPTION OF THE DRAWINGS

The accompanying drawings are included to provide a further understanding of the application, and are incorporated in and constitute a part of this specification. The drawings illustrate embodiments of the application and, together with the description, serve to explain the principles of the application.

FIG. 1 is a schematic view illustrating an electronic device according to an embodiment of the invention.

FIG. 2 is a schematic view illustrating a second body of FIG. 1 opening from a first body.

FIG. 3 is a perspective view illustrating a hinge structure of FIG. 1.

FIG. 4 is an exploded view illustrating the hinge structure of FIG. 3.

FIG. 5 is a perspective view illustrating a convex cam of FIG. 3.

FIG. 6 is a perspective view illustrating a concave cam of FIG. 3.

FIG. 7 is a schematic view illustrating a first friction surface of FIG. 5 contacting a second friction surface of FIG. 6.

FIG. 8 is a schematic view illustrating the convex cam of FIG. 5 engaged with the concave cam of FIG. 6.

FIG. 9 is a schematic view illustrating a reduction of an angle between the first body and the second body of FIG. 2.

FIG. 10 is an enlarged view of a first washer of FIG. 4.

### DETAILED DESCRIPTION OF DISCLOSED EMBODIMENTS

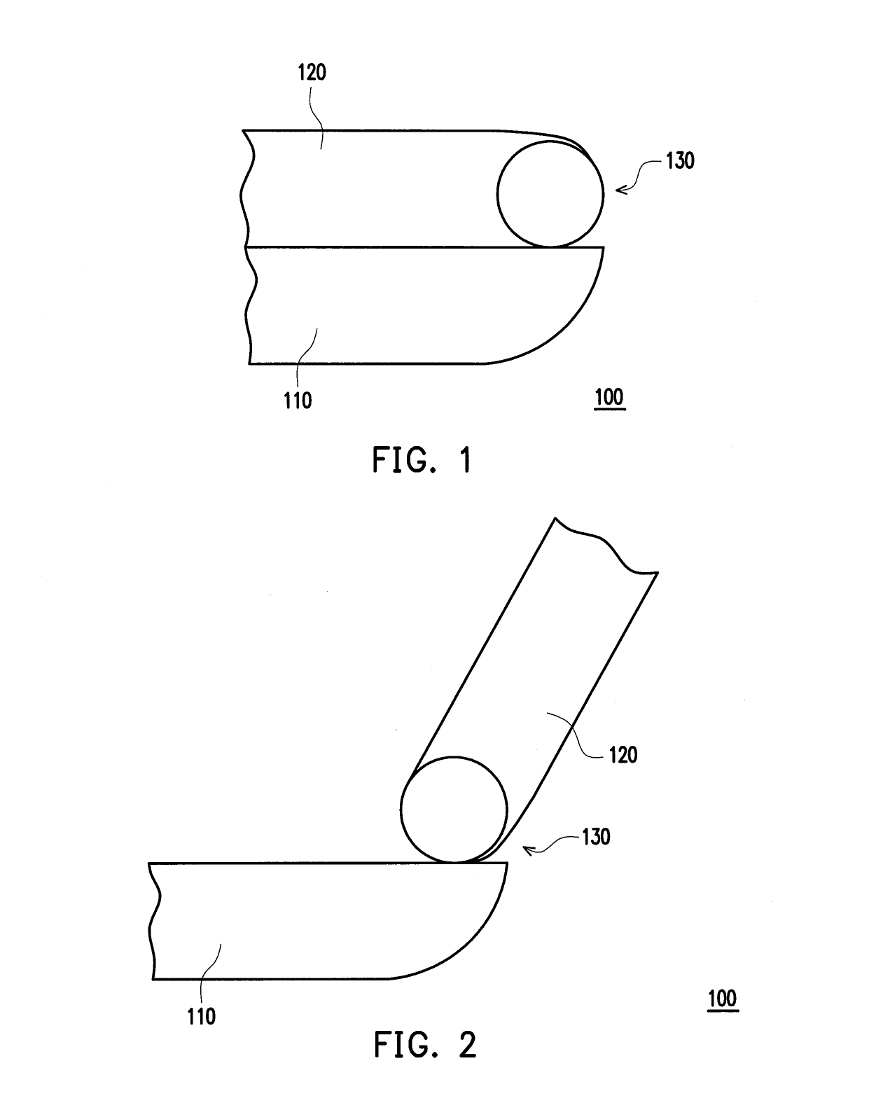

FIG. 1 is a schematic view illustrating an electronic device according to an embodiment of the invention. FIG. 2 is a schematic view illustrating a second body of FIG. 1 opening from a first body. Referring to FIG. 1 and FIG. 2, an electronic device 100 of the present embodiment of the invention, for example, is a notebook computer and includes a first body 110, a second body 120 and a hinge structure 130. The first body 110 and the second body 120, for example, are a host and a display of the notebook computer, respectively, and are coupled to each other via the hinge structure 130, so that the second body 120 may be opened in relative to the first body 110, as shown in FIG. 2.

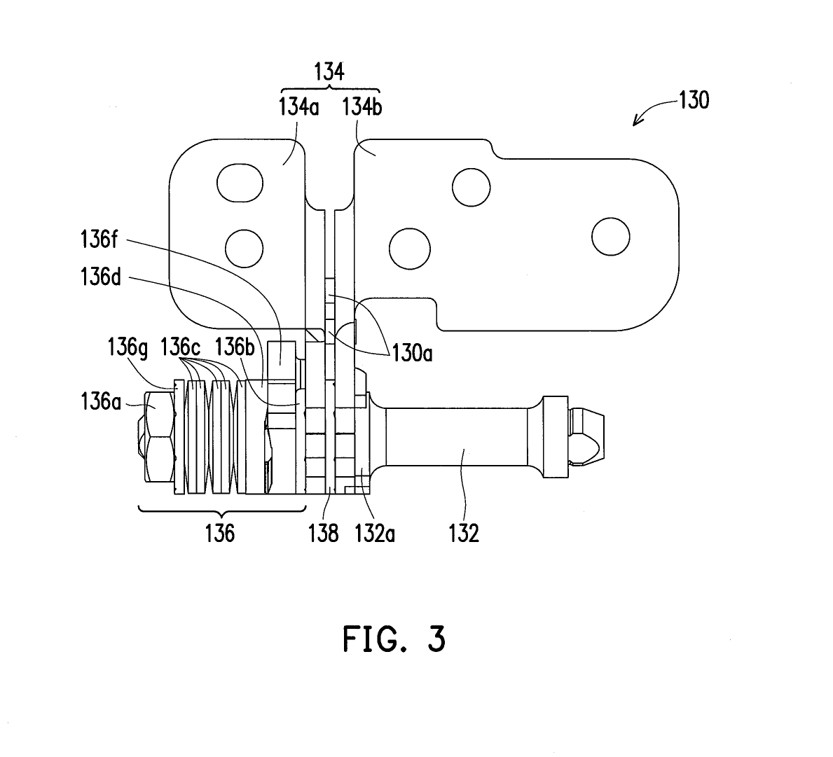

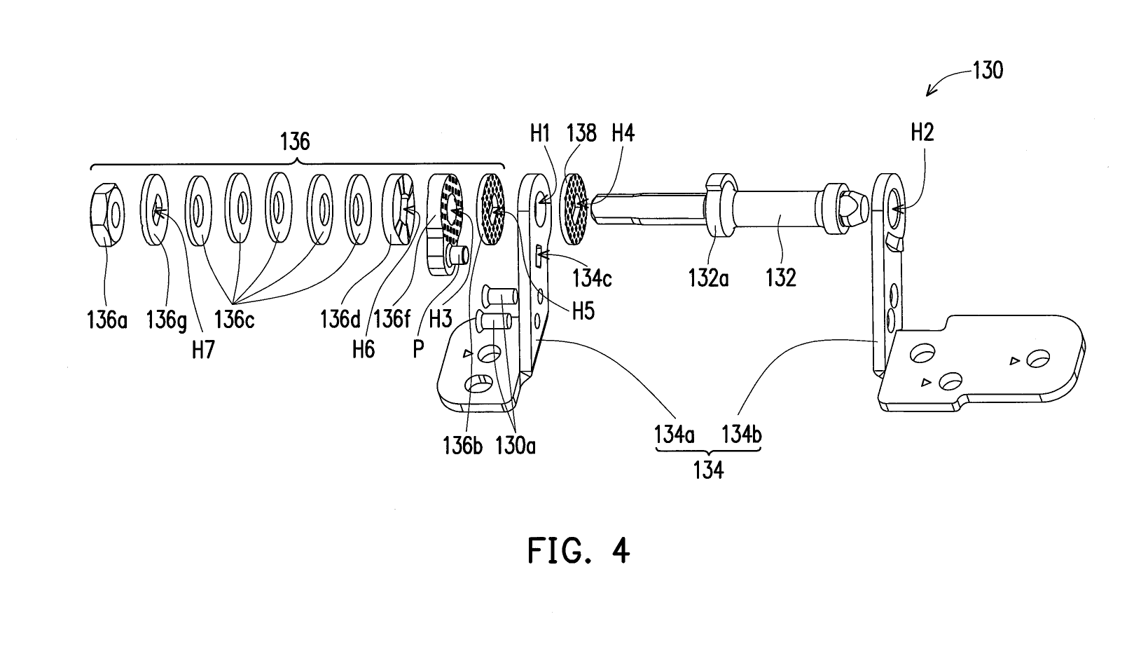

FIG. 3 is a perspective view illustrating a hinge structure of FIG. 1. FIG. 4 is an exploded view illustrating the hinge structure of FIG. 3. Referring to FIG. 3 and FIG. 4, in detail, the hinge structure 130 includes a shaft 132, a bracket 134, a torsion assembly 136 and a first washer 138. The shaft 132 is fixed to the first body 110 depicted by FIG. 1, the bracket 134 is fixed to the second body 120 depicted by FIG. 1 and rotatably connected to the shaft 132, so that the second body 120 may be opened from or closed to the first body 110 following a relative rotation of the shaft 132 and the bracket 134. The torsion assembly 136 is disposed at the shaft 132 and provides torsion to the hinge structure 130. The bracket 134 includes an assembling portion 134a and an assembling portion 134b fixed to each other, wherein the assembling portion 134a and the assembling portion 134b, for example, are fixed to each other via a rivet 130a. The first washer 138 is fixed to the shaft 132 and located between the assembling portion 134a and the assembling portion 134b, and two sides of the first washer 138 respectively contact the assembling portion 134a and the assembling portion 134b.

Under the abovementioned configuration, through contacts between the first washer 138 and each of the assembling portions, the hinge structure 130 may have more frictional interfaces. As such, the hinge structure 130, in addition to providing the torsion required by the electronic device 100 during the opening and closing of the first body 110 and the second body 120 via the torsion assembly 136, may also further increase the torsion through the frictional force between the first washer 138 and the two assembling portions (the assembling portion 134a and the assembling portion 134b), so as to prevent the torsion of the hinge structure 130 from an excessive attenuation due to repetitive openings and closings of the first body 110 and the second body 120, and thereby enhance a durability of the electronic device 100.

In the following, the structure of the torsion assembly 130 of the present embodiment is specifically illustrated with drawings. Referring to FIG. 3 and FIG. 4, the shaft 132 of the present embodiment has a stopper portion 132a, the torsion assembly 136 includes a pressing element 136a, a second washer 136b and a plurality of elastic pieces 136c (five are drawn). The bracket 134 is located between the stopper portion 132a and the pressing element 136a. The second washer 136b is fixed to the shaft 132 and located between the bracket 134 and the pressing element 136a, and the second washer 136b contacts the bracket 134 to provide torsion to the hinge structure 130 through the frictional force between the second washer 136b and the bracket 134. The pressing element 136a, for example, is a screw nut, is fixed to the shaft 132 by screwing, and provides a pressure toward the stopper portion 132a along an axial direction of the shaft 132. The elastic pieces 136c are disposed at the shaft 132 and located between the second washer 136b and the pressing element 136a, and the third washer 136g is disposed between the pressing element 136a and the elastic pieces 136c. The pressing element 136a transmits the pressure toward the stopper portion 132a through the elastic pieces 136c, such that sufficient frictional force is generated between the first washer 138 and the bracket 134 produce therebetween, and sufficient frictional force is generated between the second washer 136b and the bracket 134, so as to provide proper torsion to the hinge structure 130. In addition, the bracket 134 contacts the stopper portion 132a of the shaft 132 to provide torsion to the hinge structure 130 through frictional force between the bracket 134 and the stopper portion 132a.

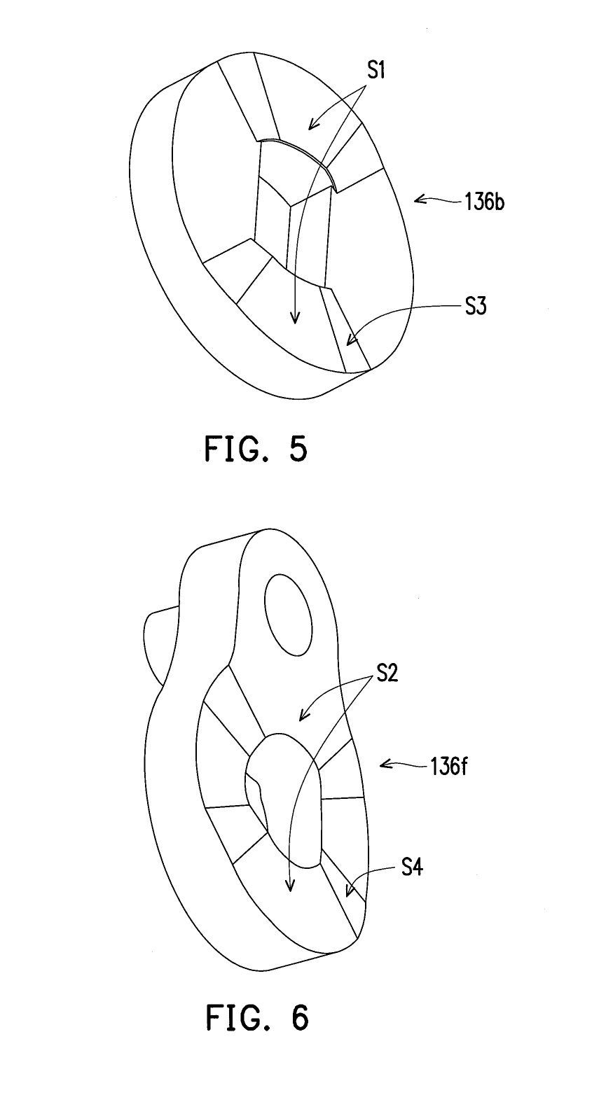

FIG. 5 is a perspective view illustrating a convex cam of FIG. 3. FIG. 6 is a perspective view illustrating a concave cam of FIG. 3. Referring to FIG. 3 through FIG. 6, in the present embodiment, the torsion assembly 136 further includes a convex cam 136d and a concave cam 136f, and the convex cam 136d and the concave cam 136f are fixed to the shaft 132 and located between the second washer 136b and the elastic pieces 136c. The convex cam 136d has at least one first friction surface S1 (illustrated as two), the concave cam 136f has at least one second friction surface S2 (illustrated as two), and the first friction surface Si and the second friction surface S2 are configured to contact with each other to provide torsion to the hinge structure 130 through frictional force between the convex cam 136d and the concave cam 136f. In addition, the second washer 136b contacts the concave cam 136f to provide torsion to the hinge structure 130 through frictional force between the second washer 136b and the concave cam 136f.

As described above, the hinge structure 130 of the present embodiment forms four frictional interfaces between the second washer 136b and the bracket 134, between the bracket 134 and the stopper portion 132a, between the convex cam 136d and the concave cam 136f, and between the second washer 136b and the concave cam 136f, so as to provide torsion to the hinge structure 130. Furthermore, by disposing the first washer 138 between the assembling portion 134a and the assembling portion 134b of the bracket 134, two frictional interfaces are formed between the first washer 138 and the two assembling portions, such that the frictional interfaces of the hinge structure 130 are increased into six, so as to effectively prevent the torsion of the hinge structure 130 from an excessive attenuation due to the repetitive openings and closings of the first body 110 and the second body 120.

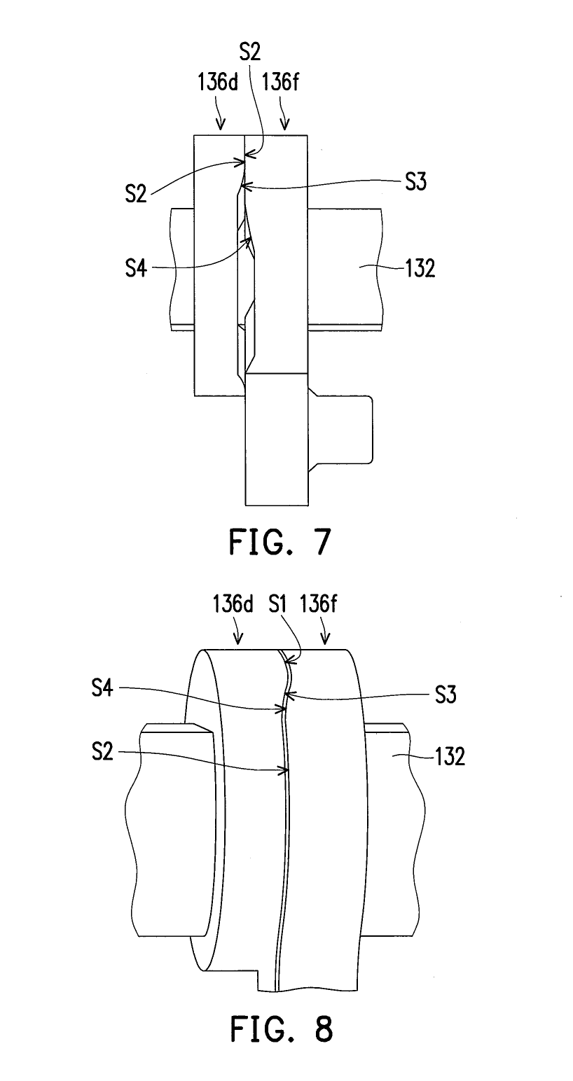

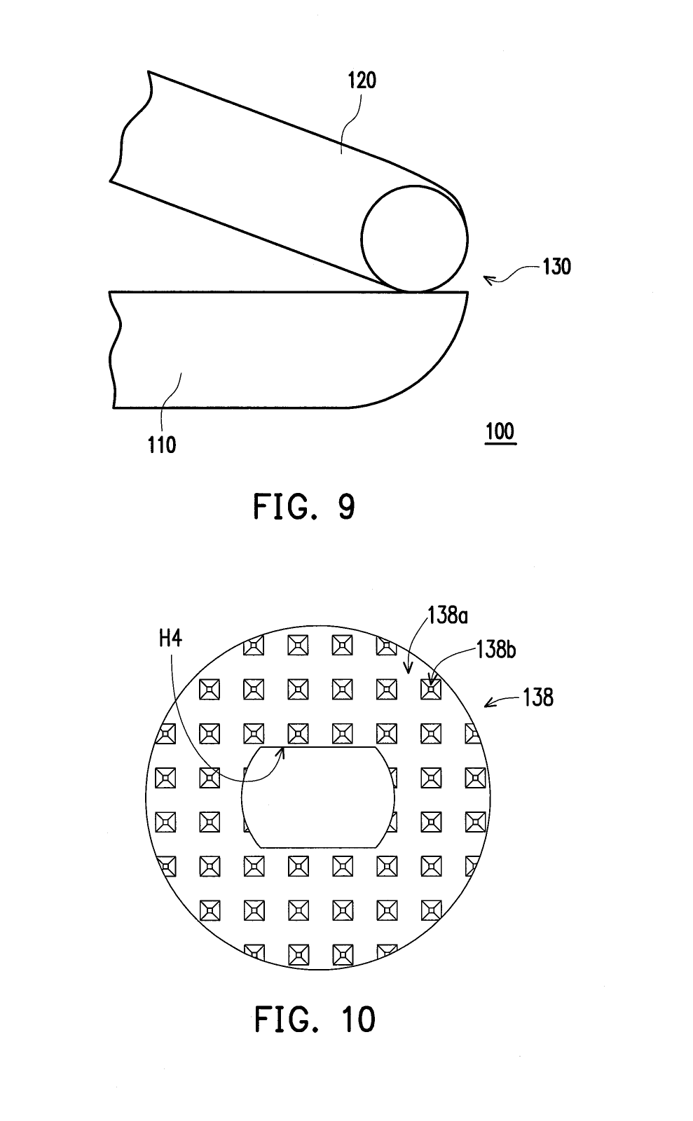

FIG. 7 is a schematic view illustrating a first friction surface of FIG. 5 contacting a second friction surface of FIG. 6. FIG. 8 is a schematic view illustrating the convex cam of FIG. 5 engaged with the concave cam of FIG. 6. FIG. 9 is a schematic view illustrating a reduction of an angle between the first body and the second body of FIG. 2. Referring to FIG. 5 through FIG. 8, in the present embodiment, the convex cam 136d has a first guiding inclined plane S3 (illustrated as a plurality) adjacent to the first friction surface S1, and the concave cam 136f has a second guiding inclined plane S4 (illustrated as a plurality) adjacent to the second friction surface S2. When an angle between the first body 110 and the second body 120, as shown in FIG. 2, is greater than a preset angle (the preset angle of the present embodiment, for example, is 20 degrees), the first friction surface S1 of the convex cam 136d and the second friction surface S2 of the concave cam 136f contact with each other, as shown in FIG. 7, so as to provide torsion to the hinge structure 130 through the frictional force between the convex cam 136d and the concave cam 136f. When the angle between the first body 110 and the second body 120 is reduced to the aforementioned preset angle (e.g., 20 degrees) following a rotation of the bracket 134 (illustrated in FIG. 3 and FIG. 4) in relative to the shaft 132, as shown in FIG. 9, the first guiding inclined plane S3 of the convex cam 136d begins to contact the second guiding inclined plane S4 of the concave cam 136f, and the pressured provided by the pressing element 136a (illustrated in FIG. 3 and FIG. 4) drives the first guiding inclined plane S3 to slide in relative to the second guiding inclined plane S4, so that the bracket 134 continues to rotate in relative to the shaft 132 and drives the first body 110 to be closed to the second body 120, as shown in FIG. 1; now, the convex cam 136d and the concave cam 136f are rotated in relative to each other until a state of engagement, as shown in FIG. 8, is reached. With this, when a user closes the second body 120 into a state shown in FIG. 9, the second body 120 is automatically closed into a state shown in FIG. 1 with the aforementioned action principle, so as to prevent the first body 110 and the second body 120 from being unable to actually close with each other.

Referring to FIG. 4, the assembling portion 134a of the present embodiment has a shaft hole H1, the assembling portion 134b has a shaft hole H2, and the concave cam 136f has a shaft hole H3 so as to enable the assembling portion 134a, the assembling portion 134b and the concave cam 136f to rotatably connect to the shaft 132 respectively through the shaft hole H1, the shaft hole H2 and the shaft hole H3. The concave cam 136f further has a convex pillar P and the assembling portion 134a further has an assembly aperture 134c, so as to enable the concave cam 136f and the bracket 134 to fix to each other through the convex pillar P and the assembly aperture 134c. In addition, the first washer 138 of the present embodiment has a non-circular hole H4 (also labeled in FIG. 10), the second washer 136b has a non-circular hole H5, the convex cam 136d has a non-circular hole H6, and the third washer 136g has a non-circular hole H7, so as to enable the first washer 138, the second washer 136b, the convex cam 136d and the third washer 136g to fix to the shaft 132 through respectively coordinating the non-circular hole H4, the non-circular hole H5, the non-circular hole H6 and the non-circular hole H7 with the shape of the shaft 132.

FIG. 10 is an enlarged view of a first washer of FIG. 4. Referring to FIG. 10, a surface 138a of the first washer 138 of the present embodiment configured to contact the bracket 134 has a plurality of grooves 138b, and the grooves 138b are configured to accommodate lubricating oil for preventing the first washer 138 and the bracket 134 from being attenuated during relative rotation with each other. Similarly, a surface of the concave cam 136f configured to contact the second washer 136b also has a plurality of grooves configured to accommodate the lubricating oil for preventing the concave cam 136f and the second washer 136b from being attenuated during relative rotation with each other. A surface of the second washer 136b configured to contact the bracket 134 may also have a plurality of grooves configured to accommodate the lubricating oil from preventing the second washer 136b and the bracket 134 from being attenuated during relative rotation with each other.

In summary, the bracket of the invention is composed of the two assembling portions fixed to each other, and the two assembling portions are disposed with the first washer therebetween, so that the hinge structure may have more frictional interfaces through the contacts between the first washer and each of the assembling portions. As such, the hinge structure, in addition to providing the torsion required by the electronic device during the opening and closing of the first body and the second body through the frictional force between the second washer and bracket, the frictional force between the convex cam and the concave cam, and the frictional force between the second washer and the concave cam, may also further increase the torsion through the frictional force between the first washer and the two assembling portions, so as to prevent the torsion of the hinge structure from an excessive attenuation due to repetitive openings and closings of the first body and the second body, and thereby enhance a durability of the electronic device.

It will be apparent to those skilled in the art that various modifications and variations can be made to the structure of the application without departing from the scope or spirit of the application. In view of the foregoing, it is intended that the application cover modifications and variations of this application provided they fall within the scope of the following claims and their equivalents.

1. An electronic device comprising:
a first body;
a second body; and
a hinge structure comprising:
a shaft fixed to the first body;
a bracket fixed to the second body and rotatably connected to the shaft, wherein the bracket comprises two assembling portions fixed to each other, wherein the two assembling portions are adapted to be fixed to each other without the shaft;
a torsion assembly disposed at the shaft and providing torsion to the hinge structure; and
a first washer fixed to the shaft and located between the two assembling portions, wherein two sides of the first washer contact the two assembling portions respectively to increase the torsion of the hinge structure through frictional force between the first washer and the two assembling portions.

2. The electronic device as recited in claim 1, wherein the shaft has a stopper portion, the torsion assembly comprises:
a pressing element fixed to the shaft, wherein the bracket is located between the stopper portion and the pressing element, and the pressing element provides a pressure toward the stopper portion along an axial direction of the shaft;
a second washer fixed to the shaft and located between the bracket and the pressing element, wherein the second washer contacts the bracket to provide torsion to the hinge structure through frictional force between the second washer and the bracket; and
a plurality of elastic pieces disposed at the shaft and located between the second washer and the pressing element, wherein the pressing element transmits the pressure through the elastic pieces towards the stopper portion.

3. The electronic device as recited in claim 2, wherein the bracket contacts the stopper portion to provide torsion to the hinge structure through frictional force between the bracket and the stopper portion.

4. The electronic device as recited in claim 2, wherein the torsion assembly further comprises a convex cam and a concave cam, the convex cam and the concave cam are located between the second washer and the elastic pieces, the convex cam is fixed to the shaft and has a first friction surface, the concave cam is fixed to the bracket and has a second friction surface, and the first friction surface and the second friction surface are configured to contact with each other to provide torsion to the hinge structure through frictional force between the convex cam and the concave cam.

5. The electronic device as recited in claim 4, wherein the convex cam has a first guiding inclined plane adjacent to the first friction surface, the concave cam has a second guiding inclined plane adjacent to the second friction surface, when an angle between the first body and the second body is greater than a preset angle, the first friction surface and second friction surface contact with each other, and when the angle between the first body and the second body is reduced to the preset angle following a rotation of the bracket in relative to the shaft, the first guiding inclined plane begins to contact with the second guiding inclined plane and the pressure provided by the pressing element drives the first guiding inclined plane to slide in relative to the second guiding inclined plane, so that the bracket continues to rotate in relative to the shaft and drives the first body to be closed to the second body.

6. The electronic device as recited in claim 4, wherein the second washer contacts the concave cam to provide torsion to the hinge structure through frictional force between the second washer and the concave cam.

7. The electronic device as recited in claim 4, wherein a surface of the concave cam is configured to contact the second washer, the surface has a plurality of grooves, and the grooves are configured to accommodate lubricating oil.

8. The electronic device as recited in claim 2, wherein a surface of the second washer is configured to contact the bracket, the surface has a plurality of grooves, and the grooves are configured to accommodate lubricating oil.

9. The electronic device as recited in claim 1, wherein a surface of the first washer is configured to contact the bracket, the surface has a plurality of grooves, and the grooves are configured to accommodate lubricating oil.

10. A hinge structure adapted to be used in an electronic device, the electronic device comprising a first body and a second body, the hinge structure comprising:
a shaft fixed to the first body;
a bracket fixed to the second body and rotatably connected to the shaft, wherein the bracket comprises two assembling portions fixed to each other, wherein the two assembling portions are adapted to be fixed to each other without the shaft;
a torsion assembly disposed at the shaft and providing torsion to the hinge structure; and
a first washer fixed to the shaft and located between the two assembling portions, wherein two sides of the first washer contact the two assembling portions respectively to increase the torsion of the hinge structure through frictional force between the first washer and the two assembling portions.

11. The hinge structure as recited in claim 10, wherein the shaft has a stopper portion, the torsion assembly comprises:
a pressing element fixed to the shaft, wherein the bracket is located between the stopper portion and the pressing element, and the pressing element provides a pressure toward the stopper portion along an axial direction of the shaft;
a second washer fixed at the shaft and located between the bracket and the pressing element, wherein the second washer contacts the bracket to provide torsion to the hinge structure through frictional force between the second washer and the bracket; and
a plurality of elastic pieces disposed at the shaft and located between the second washer and the pressing element, wherein the pressing element transmits the pressure through the elastic pieces towards the stopper portion.

12. The hinge structure as recited in claim 11, wherein the bracket contacts the stopper portion to provide torsion to the hinge structure through frictional force between the bracket and the stopper portion.

13. The hinge structure as recited in claim 11, wherein the torsion assembly further comprises a convex cam and a concave cam, the convex cam and the concave cam are located between the second washer and the elastic pieces, the convex cam is fixed at the shaft and has a first friction surface, the concave cam is fixed at the bracket and has a second friction surface, and the first friction surface and the second friction surface are configured to contact with each other to provide torsion to the hinge structure through frictional force between the convex cam and the concave cam.

14. The hinge structure as recited in claim 13, wherein the convex cam has a first guiding inclined plane adjacent to the first friction surface, the concave cam has a second guiding inclined plane adjacent to the second friction surface, when an angle between the first body and the second body is greater than a preset angle, the first friction surface and second friction surface contact with each other, and when the angle between the first body and the second body is reduced to the preset angle following a rotation of the bracket in relative to the shaft, the first guiding inclined plane begins to contact with the second guiding inclined plane and the pressure provided by the pressing element drives the first guiding inclined plane to slide in relative to the second guiding inclined plane, so that the bracket continues to rotate in relative to the shaft and drives the first body to be closed to the second body.

15. The hinge structure as recited in claim 13, wherein the second washer contacts the concave cam to provide torsion to the hinge structure through frictional force between the second washer and the concave cam.

16. The hinge structure as recited in claim 13, wherein a surface of the concave cam is configured to contact the second washer, the surface has a plurality of grooves, and the grooves are configured to accommodate lubricating oil.

17. The hinge structure as recited in claim 11, wherein a surface of the second washer is configured to contact the bracket, the surface has a plurality of grooves, and the grooves are configured to accommodate lubricating oil.

18. The hinge structure as recited in claim 10, wherein a surface of the first washer is configured to contact the bracket, the surface has a plurality of grooves, and the grooves are configured to accommodate lubricating oil.
